(19) United States
(12) Patent Application Publication
(10) Pub. No.: US 2024/0406198 A1
(43) Pub. Date: Dec. 5, 2024

(54) Domain Name System Threat Hunting Using Domain Name Tokenization

(71) Applicant: International Business Machines Corporation, Armonk, NY (US)

(72) Inventors: Jerry Pan, Roswell, GA (US); Cheng-Ta Lee, Cumming, GA (US); Robert P. Bates, Atlanta, GA (US); Brian McKay Byrne, Atlanta, GA (US); Rong Wu, Marietta, GA (US); Yosef Getachew, Stone Mountain, GA (US); Xiaoping Hu, Alpharetta, GA (US)

(21) Appl. No.: 18/328,213

(22) Filed: Jun. 2, 2023

(51) Int. Cl. H04L 9/40

(52) U.S. Cl. CPC H04L 63/1425

(57) ABSTRACT

A computer implemented method analyzes a domain name. A number of processor units identifies the domain name for analysis. The number of processor units splits the domain name into tokens. The number of processor units combines the tokens into different arrangements to form permutated domain names. The number of processor units identifies features for the permutated domain names using a set of domain name databases. The number of processor units analyze the permutated domain names with the features to determine a maliciousness of the domain name.

### BACKGROUND

The disclosure relates generally to an improved computer system and more specifically to identifying malicious domain names.

The domain name system (DNS) is a hierarchical and decentralized system for computer services and other resources on the Internet or other Internet Protocol (IP) networks. This system translates human readable domain names into IP addresses that are used to identify and locate services, devices, and other resources on the Internet.

Many threat campaigns are present that attempt to obtain information such as login credentials, credit card numbers, and other information from users. These campaigns can use fraudulent domain names to redirect users to malicious websites that intercept data or perform other malicious actions. These threat campaigns use the domain name system as part of the communications channel because the DNS is difficult to bypass. For example, phishing websites often have at least one DNS record, and it is common to see a list of C2 domains used in botnet campaigns.

A threat actor can register a domain name that is similar in appearance to a legitimate domain name. This domain name can then be used to create a fraudulent website that appears as a legitimate website in an effort to cause users to enter information such as login information or other confidential information. In other cases, the domain name may be used to distribute malware. With botnet campaigns, a C2 domain is used by malware to communicate with the threat actor's server or servers.

Information technology (IT) and security professionals can employ various techniques to analyze and monitor DNS traffic to identify patterns and indicators that compromises had occurred. For example, some analysis tools include DGA analytic, phishing analytic, and WHOIS analytic.

A domain generation algorithm (DGA) is an algorithm that can be used to generate large numbers of domain names. A DGA analytic can be used to identify patterns and algorithms used to generate the domain names and monitor DNS traffic for the domain names that may be used in threat campaigns. A phishing analytic can be used to monitor email traffic for suspicious links and identify content and structure of phishing websites. This type of analytic can use machine learning and other techniques to identify new and emerging phishing threats.

A WHOIS analytic analyzes databases of registered domain names and can be used to identify patterns and anomalies that indicate a malicious domain name. For example, the analysis can identify threat actors who have previously registered domain names for malicious purposes. This type of analytic can also identify domain name hijacking or typosquatting.

### SUMMARY

According to one illustrative embodiment, a computer implemented method analyzes a domain name. A number of processor units identifies the domain name for analysis. The number of processor units splits the domain name into tokens. The number of processor units combines the tokens into different arrangements to form permutated domain names. The number of processor units identifies features for the permutated domain names using a set of domain name databases. The number of processor units analyze the permutated domain names with the features to determine a maliciousness of the domain name. According to other illustrative embodiments, a computer system and a computer program product for analyzing a domain are provided.

### BRIEF DESCRIPTION OF THE DRAWINGS

FIG. 1 is a block diagram of a computing environment in accordance with an illustrative embodiment;

FIG. 2 is a block diagram of a threat analysis environment in accordance with an illustrative embodiment;

FIG. 3 is pictorial illustration of dataflow and of analyzing a domain name in accordance with an illustrative of embodiment;

FIG. 4 is a flowchart of a process for analyzing domain names in accordance with an illustrative embodiment;

FIG. 5 is a flowchart of a process for analyzing a domain name in accordance with an illustrative embodiment;

FIG. 6 is a flowchart of a process for performing a set of actions in accordance with an illustrative embodiment;

FIG. 7 is a flowchart of a process for analyzing permutated domain names with features in accordance with an illustrative embodiment; and

FIG. 8 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

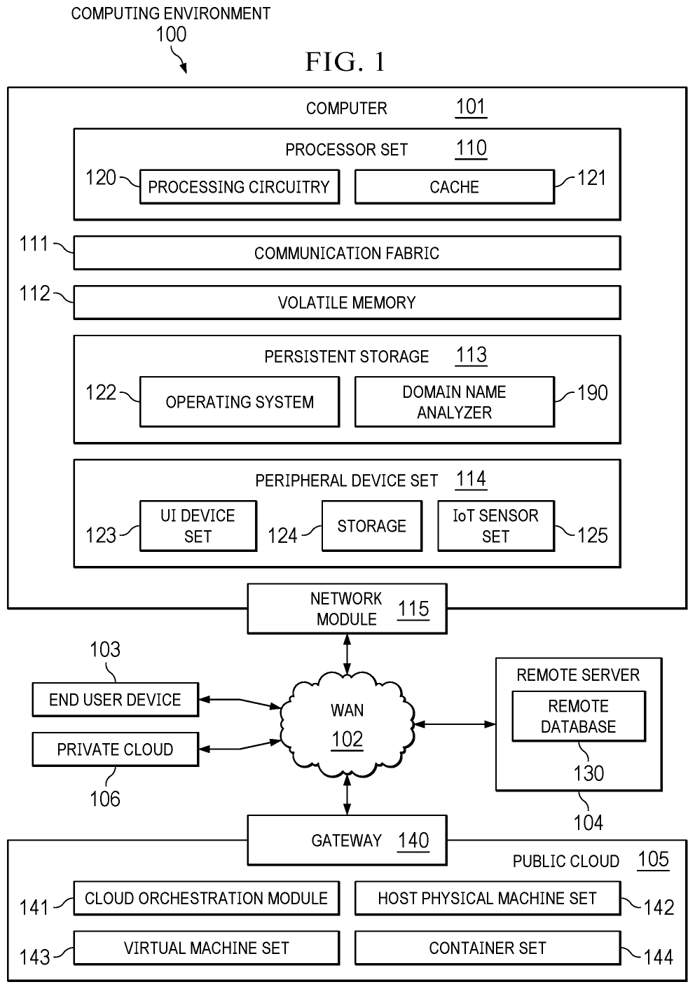

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as domain name analyzer 190. In addition to domain name analyzer 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and domain name analyzer 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in domain name analyzer 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in domain name analyzer 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative examples recognize and take into account a number of different considerations as described herein. Millions of new domains are showing up on the Internet. Although DGA analytic, phishing analytic, and WHOIS analytic are useful, it still is challenging to identify the maliciousness of a single domain name. This type of identification becomes more difficult with a newly created domain name. For example, when a threat actor has recently registered a domain name, only a few DNS records may be present. Additionally, the domain name may have no activity.

A limited number of features can be identified from a single domain name. This limited information can limit the usefulness of current analytics used to identify malicious domain names. For example, convolutional neural networks (CNN) used for identifying malicious domains name typically need more features than a random forest. As a result, gathering more relevant features from a domains name to identify the maliciousness of the domains names is still a challenge in the area of cybersecurity.

Thus, the illustrative examples provide a computer implemented method, apparatus, system, and computer program product for analyzing a domain name. In one illustrative example, a computer implemented method analyzes a domain name. A number of processor units identifies the domain name for analysis. The number of processor units splits the domain name into tokens. The number of processor units combines the tokens into different arrangements to form permutated domain names. The number of processor units identifies features for the permutated domain names using a set of domain name databases. The number of processor units analyze the permutated domain names with the features to determine a maliciousness of the domain name.

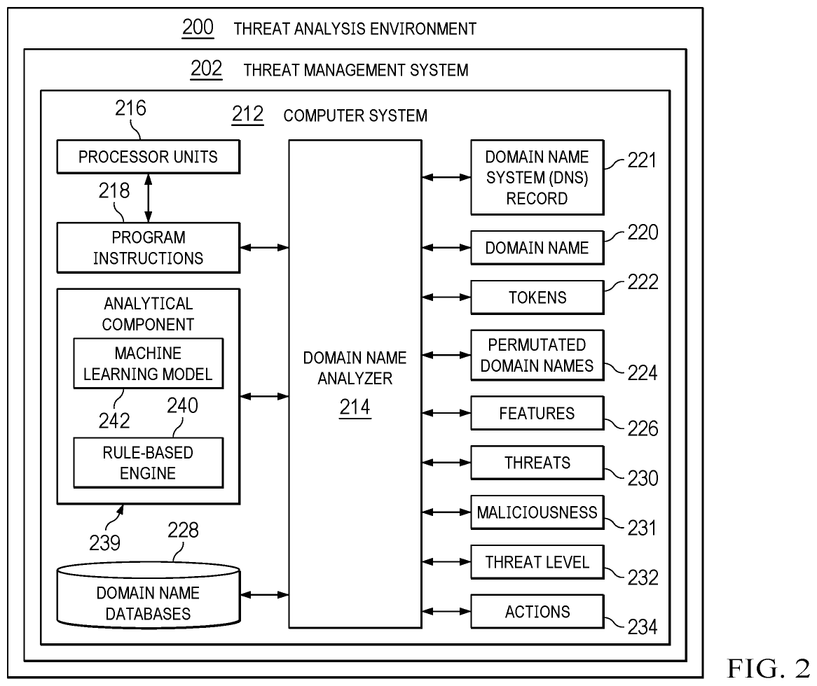

With reference now to FIG. 2, a block diagram of a threat analysis environment is depicted in accordance with an illustrative embodiment. In this illustrative example, threat analysis environment 200 includes components that can be implemented in hardware such as the hardware shown in computing environment 100 in FIG. 1.

In this illustrative example, threat management system 202 in threat analysis environment 200 can be used for threat detection and threat hunting in a domain name system for increasing network security. In this illustrative example, threat management system 202 comprises a number of components. As depicted, threat management system 202 comprises computer system 212 and domain name analyzer 214. Domain name analyzer 214 is located in computer system 212. Domain name analyzer 214 may be implemented using domain name analyzer 190 in FIG. 1.

Domain name analyzer 214 can be implemented in software, hardware, firmware or a combination thereof. When software is used, the operations performed by domain name analyzer 214 can be implemented in program instructions configured to run on hardware, such as a processor unit. When firmware is used, the operations performed by domain name analyzer 214 can be implemented in program instructions and data and stored in persistent memory to run on a processor unit. When hardware is employed, the hardware can include circuits that operate to perform the operations in domain name analyzer 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, domain name analyzer 214 identifies domain name 220 for analysis. The identification can be performed in a number of different ways. For example, domain name 220 can be received as a user input. In another example, domain name 220 can be identified from domain name system (DNS) record 221. In yet other examples, domain name 220 can be identified in other data structures such a webpage, an email message, a document, or other sources in which domain name 220 can be located.

Domain name analyzer 214 splits domain name 220 into tokens 222. In this illustrative example, the generation of tokens from domain name 220 can be performed using various natural language algorithms available for creating tokens from strings.

The splitting of domain name 220 can be performed in a number of different ways. For example, word tokenization of domain name 220 into tokens 222 can be performed using a tokenization technique that splits a given string based on one or more English dictionary words contained in domain name 220.

Word tokenization can be performed by domain name analyzer 214 using currently available natural language processing (NLP) techniques. These techniques can be implemented in machine learning models or other types of n-gram language models trained on large written text corpora. These models can implement a maximal matching (MM) dynamic programming algorithm.

In one example, the splitting of domain name 220 can split the words in domain name 220 into tokens 222 but exclude the top level domain (TLD) as part of this process. For example, with the domain name “signin.pnconlinebanking.com” the splitting can be performed on “signin.pconlinebanking” leaving out “com”.

In other examples, the splitting may only involve a portion of the domain name. For example, the splitting can be performed using the second level domain “pconlinebanking” in this domain name. With this example, “signin” is the subdomain and may not be used to create tokens in some examples.

Domain name analyzer 214 combines tokens 222 into different arrangements to form permutated domain names 224. In this example, permutated domain names 224 can be of all different possible combinations and permutations of tokens 222 identified from domain name 220. For example, permutated domain names 224 can include domain names created from tokens 222 taken from a root domain of domain name 220.

In this example, domain name analyzer 214 identifies features 226 for permutated domain names 224 using a set of domain name databases 228. Features 226 can take different forms. For example, features 226 can be selected from at least one of an Internet Protocol address, a registrar name, a registrant name, registrant information, an administrative contact, a technical contact, a name server, a domain status, a creation date for a registered domain name, an expiration date for the registered domain name, a threat actor, a threat level, a maliciousness level, or other information.

In one illustrative example, the set of domain name databases 228 can be selected from at least one of a domain registration database, a domain name system database, a domain lookup database, a threat intelligence database, a threat intelligence domain database, a threat intelligence index, or other suitable databases or collections of data.

For example, a WHOIS database can be queried to obtain WHOIS records for permutated domain names 224. In other words, the query can be made to see whether some or all of permutated domain names 224 are registered. The information in these WHOIS records can be used to enrich permutated domain names 224 by associating features derived from WHOIS records with permutated domain names 224. Further, the presence or absence of records for permutated domain names 224 are also considered features for these domain names. In this manner, additional features can be obtained for domain name 220 based on features 226 for permutated domain names 224 in addition to features 226 bound for domain name 220.

Features 226 can be obtained from other sources in domain name databases 228. For example, a threat intelligence database for threat intelligence index can be searched for information about permutated domain names 224. Features from these databases can be added to permutated domain names 224 to further enrich these permutated domain names for analysis.

Domain name analyzer 214 analyzes permutated domain names 224 with features 226 for threats 230 to determine maliciousness 231 of domain name 220. Domain name analyzer 214 can perform the analysis using a number of different mechanisms. For example, domain name analyzer 214 can use analytical component 239. This component can be selected from at least one of rule-based engine 240, machine learning model 242, or some other suitable system.

In this illustrative example, the analysis of the permutated domain names with features can be performed to determine threat level 232 for domain name 220. In this example, threat level 232 can be one measure of threats 230. For example, threat level 232 can be selected from a scale comprising low threat level, moderate level, high threat level, and critical threat level.

In this example, a low level threat level may apply to domain names that seem suspicious from the analysis, but no actual evidence of malicious activity is present. Moderate threat levels may include some indicators of malicious activity. For example, permutated domain names 224 may show malicious activity and may be associated with domain name 220. This association may be identified from features 226 such as a common registrar, a common registrant, or other identifier that is tied to or related to malicious activities. A high threat level can be present when one or more permutated domain names 224 are associated with domain name 220 and those permutated domain names have been identified as participating in malicious activity such as phishing, malware attribution, or other malicious activities. The critical threat level can be used when permutated domain names 224 that have been associated with domain name 220 are associated with widespread or ongoing cyber-attacks or other activities.

In another example a numerical scale can be used. For example, a scale from 0 to 10 can be used for threat level 232. With this scale, a 0 indicates no known risk, and a 10 indicates a high risk of malicious activity.

Based on this analysis, domain name analyzer 214 can perform a set of actions 234 for domain name 220. The set of actions 234 can be based on the maliciousness of domain name 220. Maliciousness 231 of domain name 220 can be measured using metrics similar to those described for measuring threats 230 permutated domain names 224. In this illustrative example, the set of actions performed by domain name analyzer 214 can include at least one of updating a threat intelligence database, blocking a lookup of the domain name in a domain name system service, or generating an alert.

In one illustrative example, one or more technical solutions are present that overcome a technical problem with identifying features for use in analyzing a domain name to determine whether threats are present for that domain name. As a result, one or more illustrative examples can enable obtaining sufficient features for a domain name to perform an improved threat analysis for the domain name as compared to current techniques. In the illustrative examples, the domain name is split into tokens and permutations of the domain name are generated using those tokens. Features identified for the permutations of the domain name and an analysis can be performed using those features.

The illustrative examples can analyze a domain name from maliciousness without the number of features normally desired for analyzing domain names. In illustrative examples, additional features can be identified for use in analyzing the domain name through generating permutations of the domain name and identifying features for those permutations. In these illustrative examples, this analysis can be useful when domain names are new or are not found in threat databases. The illustrative example provides an approach to identify threats for domain names without needing prior knowledge of that domain name. The use of permutated domain names and the features to identify threats for those permutated domain names are used to understand the maliciousness of the domain name from which the permutated domain names are generated. As a result, the list of examples can be used to identify maliciousness of a single domain name even though few DNS records may be present and activities are not present on a website using the domain name.

Computer system 212 can be configured to perform at least one of the steps, operations, or actions described in the different illustrative examples using software, hardware, firmware or a combination thereof. As a result, computer system 212 operates as a special purpose computer system in which domain name analyzer 214 in computer system 212 enables analyzing a domain name for threats. In particular, domain name analyzer 214 transforms computer system 212 into a special purpose computer system as compared to currently available general computer systems that do not have domain name analyzer 214. Current systems are unable to perform an accurate analysis based on the features for a single domain name.

In the illustrative example, the use of domain name analyzer 214 in computer system 212 integrates processes into a practical application for method to analyze a domain name that increases the performance of computer system 212 in identifying threats for a domain name. In other words, domain name analyzer 214 in computer system 212 is directed to a practical application of processes integrated into domain name analyzer 214 in computer system 212 that splits the domain name into tokens, creates permutated domain names from the tokens, identifies features for the permutated domain names, and analyzes those features to determine a threat for the domain name.

The illustration of threat analysis environment in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, domain name analyzer 214 can operate to analyze one or more domain name system records in addition to domain name system record 221. In this manner, domain name analyzer 214 can perform an analysis of domain names found in databases such as DNS databases. Further, this analysis can be used to analyze specific domain names of interest specified by the user, used in suspicious webpages of interest, or located in some document or data structure.

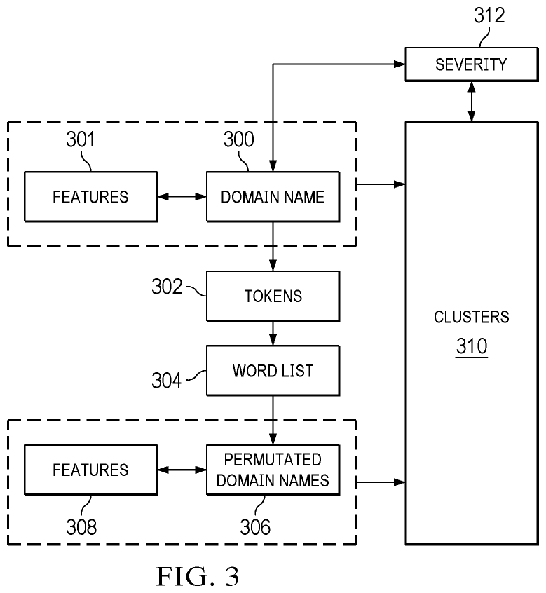

With reference next to FIG. 3, a pictorial illustration of dataflow and of analyzing a domain name is depicted in accordance with an illustrative of embodiment. In this example, the dataflow can be implemented using domain name analyzer 214 in FIG. 2.

Domain name 300 can be analyzed to determine threats that this domain name may pose. In this example, domain name 300 is a fully qualified domain name (FQDN). A fully qualified domain name is a complete domain name for a computer, post, or other device on a network. A fully qualified domain name provides a unique name for each device on the network and can include higher level domains in the top-level domain. For example, a fully qualified domain name can be “capitaloneonlinebanking.co”.

The domain name 300 has features 301. These features can be, for example, registrar name, threat score, registrant name, and registrant country. However, these features are insufficient to easily determine whether the domain name is a suspicious domain. To obtain additional information, domain name 300 is split into tokens 302. For example, the domain name “capitaloneonlinebanking.co” has different parts. In this example “capitaloneonlinebanking” is a second level domain (SLD), “co” is a top level domain (TLD), and “capitaloneonlinebanking.com” is the root domain. In this example, the root domain is tokenized to obtain the following tokens: “capital”, “one”, “online”, “banking” and “co”. As depicted, this tokenization can be performed using currently available natural language processing models or other types of suitable machine learning models.

Not all of tokens 302 may be used. The tokens used from tokens 302 form word list 304. In this example, “capital”, “one”, “online”, “banking” is added to the list and “co” not used. Tokens 302 in word list 304 are used in different permutations to form permutated domain names 306 for domain name 300.

These permutated domain names can be enriched with additional information in the form of features 308. These features can include, for example, registrar name, threat score, registrant name, and registrant country. In other words, features 308 can be identified and associated with permutated domain names 306 for use in further analysis. For example, this information can be obtained by searching a WHOIS database to see if any of permutated domain names 306 have been registered.

From WHOIS records returned from searching the WHOIS database, features can be associated with permutated domain names for which WHOIS records are returned. For example, by examining a WHOIS record for a permutated domain name, information such as registrar name, registrant name, and registrant country are returned. Additionally, a threat database can be searched to obtain additional features such as a threat score.

Permutated domain names 306 with features 308 for permutated domain names 306 can be analyzed to determine threats that domain name 300 may pose. This analysis can include domain name 300 with features 301 for domain name 300. For example, permutated domain names 306 may be processed to identify clusters 310 based on features 308. Clustering can be used to identify clusters 310. Clustering can be performed using machine learning algorithms to place subjects in a data set into groups, based on the features of each subject.

In this example, clusters 310 can be identified using permutated domain names 306 with features 308 and domain name 300 with features 301. In this example, the clustering is not performed using features with respect to maliciousness or threat levels. The features with this information can be used after clustering to identify the maliciousness or threat of a particular cluster is considered malicious or warranting further consideration.

Further in this example, some of permutated domain names 306 may not have features 308 that can be located from searching domain name databases. In other words, no records may be present for a permutated domain name in domain name databases such as a WHOIS database or a threat database. The fact that no information is found for a particular permutated domain can be a feature for that permutated domain name.

In this example, severity 312 can be assigned to each of clusters 310. The severity can be, for example, not malicious or potentially malicious. In other examples, severity 312 can be a threat level with different levels can be assigned based scale such as zero to 10 or with labels such as low threat level, moderate level, high threat level, and critical threat level.

In this example, severity 312 for domain name 300 can be determined based on the particular cluster in which domain name 300 is located in clusters 310. Thus, the use of features 308 for permutated domain names 306 derived from domain name 300 can be used to determine severity 312 of a threat posed by domain name 300 when features 301 are sparse or nonexistent for domain name 300.

This illustration of dataflow in analyzing domain name is provided as an example and not meant to limit the manner in which other illustrative examples can be implemented. For example, domain name 300 may take other forms. For example, domain name 300 may be “login.brandoneonlinebanking.com”. In this example “login” is a subdomain, “brandoneonlinebanking” is a second level domain (SLD), “com” is a top level domain (TLD), and “brandoneonlinebanking.com” is the root domain. With this example, the tokenization can be performed on the root domain “brandoneonlinebanking.com”.

In this example, the root domain is tokenized to obtain the following tokens: “brand”, “one”, “online”, “banking” and “com”. In other illustrative examples, the subdomain may also be tokenized depending on the particular implementation. For example, the subdomain may have significance or uniqueness that may be used in the permutations.

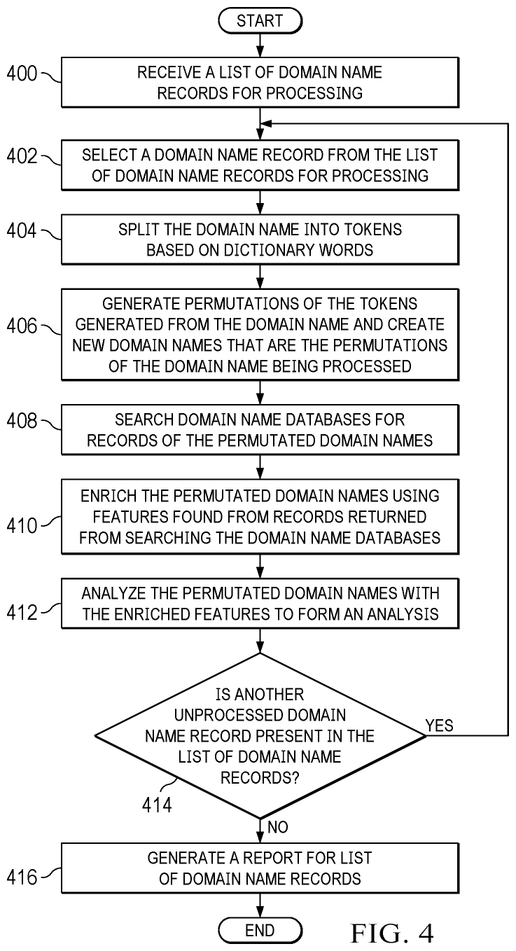

Turning next to FIG. 4, a flowchart of a process for analyzing domain names is depicted in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in domain name analyzer 214 in computer system 212 in FIG. 2. The process illustrated in this flowchart is an example of one implementation that can be performed by domain name analyzer 214.

The process begins by receiving a list of domain name records for processing (step 400). In step 400, the domain name records can be DNS lookup records from DNS providers. The process selects a domain name record from the list of domain name records for processing (step 402).

The process splits the domain name into tokens based on dictionary words (step 404). In this example, a dictionary of the dictionary words can be an English dictionary. In step 404, the strength for the domain name can be split using a tokenization scheme that splits a given string based on one or more dictionary words contained in the string. In example, the tokenization scheme can split the input string into tokens based on boundary of dictionary words.

For example, if the input string contains no dictionary words: [input_string], the output is [input_string]. If the input string contains exact three dictionary words: [input_string], the output is [word1][word2][word3]. In another example, if the input string contains two internal dictionary words plus non-dictionary parts: [input_string], the output is [aaa][word1][xxx][word2][yyy].

For example, with a domain name “sigin.pconlinebanking.com”, the tokens identified from this domain name are “pc”, “online”, and “banking”. In this case, the second level domain “pconlinebanking” is used without the subdomain “signin” and without the top level domain (TLD) “com”. As another example, the domain name “bank-of-texas-onlinebanking.com” can be tokenized using the second level domain “bank-of-texas-onlinebanking”. This results in the following: “bank”, “of”, “texas, “online”, “banking” as tokens for this domain name.

In this depicted example, tokens for dictionary words and non-words are used. In this example, a non-word is a string of characters that do not conform to normal English spelling of a word or word formation. Typical word delimiters such as “-” and “_” are left out. Additionally, stop words that are common or insignificant and natural language processing for searching and keyword comparison can also be left out in some cases. In other cases, the stop words may be included if these stop words are part of a brand name. As result, in some cases, the stop words may be significant. In these examples, a stop word is a word that has very little meaning and is not registered by search engines or other applications that process natural language.

The process generates permutations of the tokens generated from the domain name and creates new domain names that are the permutations of the domain name being processed (step 406). In step 406, the permutations can be generated any number different ways. For example, in one permutation technique, only the words found in one part of domain are used. For example, the root domain can be selected. This root domain is also referred to as the apex domain in the DNS records and is the most important part of a domain. In one example, common TLD's are used with a size of N, then with K tokens and S stop words, the permutations (P) to derive new domain names are as follows:

P=N*(K−S)! as total possible permutations

If no unwanted tokens (i.e., S=0) are present or stop words are to be retained because the stop may be significant, then the permutations (P) are:

P=N*K!

To keep both variants (filter stop words or keep them), the total possible permutations (P) would be the sum are the sum of the two options:

P=N*(K−S)!+N*K!

In another permutation technique, tokens for the root domain are used and the tokens for the subdomain and host of the domain name can be included. As a results all tokens from all parts of the domain name are used to form all possible combinations for each part in forming permutations of the domain name. As a result, more possibilities are present to combine to form a permutated domain name.

When using the first permutation technique, some of the permutated domain names formed from the domain name are “pc.com”, “pc.online.com”, “pc.online.banking.com”, “online.pc.com”, and “onlube.banking.com”, and other permutations. Thus, the different permutations of tokens can also include using different top level domains in addition to the one found in the domain name being analyzed.

The process searches domain name databases for records of the permutated domain names (step 408). In step 408, two types of domain name databases are used. In this example, a registration domain name database containing registration records is searched to identify records for the permutated domain names. This can be, for example, a WHOIS database. A second type of domain name database can be a malicious domain database containing malicious domains names can be searched to identify malicious name records for the permutated domain names.

The process enriches the permutated domain names using features found from records returned from searching the domain name databases (step 410). In this case, features have been identified for the domain name being analyzed.

The process analyzes the permutated domain names with the enriched features to form an analysis (step 412). In this example, if a domain name match is present for a permutated domain name in the registration records from the registration domain name database, original domain from which this permutated domain name is derived from becomes interesting from a threat perspective.

For example, if the permutated domain name is potentially a phishing domain that tries to impersonate the matched domain, then, the domain name may also be a phishing domain. In such cases, additional analysis may be performed to determine if the matched domain name is a brand name domain name. In this example, a brand name domain name is a well-known domain name that has recognition.

In this case, examining other features in the registration record, such as registrant, registrar, name servers, may be useful to determine whether this permutated domain name has similar features to the domain name being analyzed. On the other hand, if the permutated domain name matches an entry in the malicious domain database, then the domain name is of interest for further analysis. In this case, the domain name being analyzed can be a variance of the permutated domain name that is identified as being a malicious domain.

A determination is made as to whether another unprocessed domain name record is present in the list of domain name records (step 414). If another unprocessed record is present, the process returns to step 402. Otherwise, the process generates a report for list of domain name records (step 416). In step 416, the report identifies any detected suspicious domain names from the list of domain name records. The process terminates thereafter.

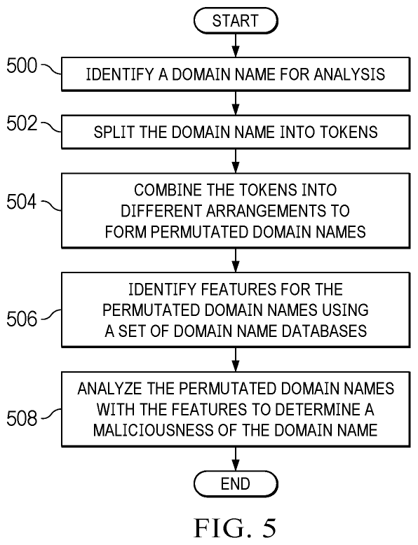

With reference next to FIG. 5, a flowchart of a process for analyzing a domain name is depicted in accordance with an illustrative embodiment. The process in FIG. 5 can be implemented in hardware, software, or both. When implemented in software, the process can take the form of program instructions that are run by one or more processor units located in one or more hardware devices in one or more computer systems. For example, the process can be implemented in domain name analyzer 214 in computer system 212 in FIG. 2. The process illustrated in this flowchart is an example of one implementation that can be performed by domain name analyzer 214.

The process begins by identifying a domain name for analysis (step 500). The process splits the domain name into tokens (step 502).

The process combines the tokens into different arrangements to form permutated domain names (step 504). In step 504, each of the permutated domain names are fully qualified domain names. The process identifies features for the permutated domain names using a set of domain name databases (step 506).

The process analyzes the permutated domain names with the features to determine a maliciousness of the domain name (step 508). The process terminates thereafter.

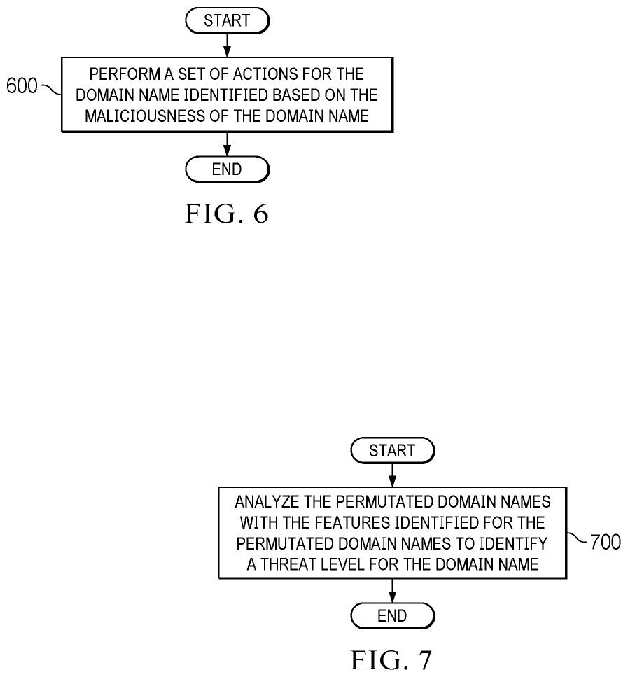

In FIG. 6, a flowchart of a process for performing a set of actions is depicted in accordance with an illustrative embodiment. The process in this figure is an example of an additional step that can be performed with the steps in FIG. 5.

The process performs a set of actions for the domain name identified based on the maliciousness of the domain name (step 600). The process terminates thereafter.

Turning next to FIG. 7, a flowchart of a process for analyzing permutated domain names with features is depicted in accordance with an illustrative embodiment. The process in this flowchart is an example of an implementation for step 508 in FIG. 5.

The process analyzes the permutated domain names with the features identified for the permutated domain names to identify a threat level for the domain name (step 700). The process terminates thereafter. This determination can be made by determining the maliciousness or threat level for permutated domain names similar to the domain name being analyzed. The similarity can be based on a similarity of features between the permutated domain names and the domain name being analyzed.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

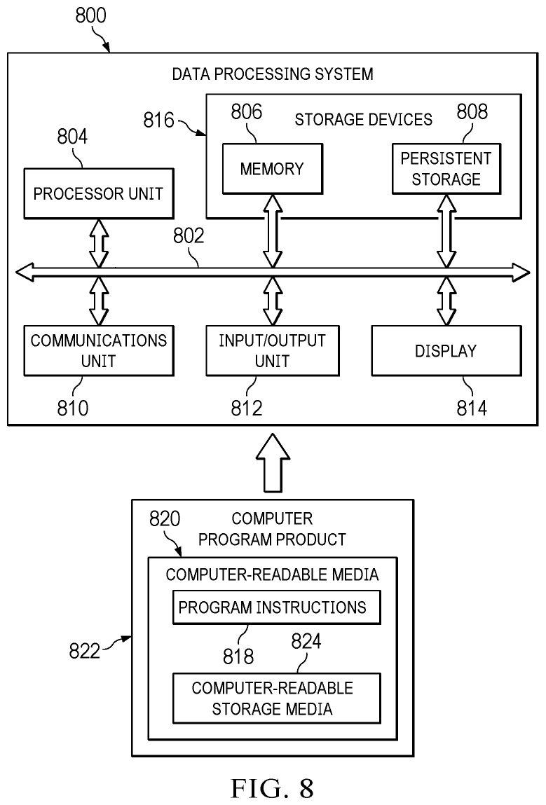

Turning now to FIG. 8, a block diagram of a data processing system is depicted in accordance with an illustrative embodiment. Data processing system 800 can be used to implement computers and computing devices in computing environment 100 in FIG. 1. Data processing system 800 can also be used to implement computer system 212 in FIG. 2. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 804 can be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 816 may also be referred to as computer readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are referred to as program instructions, computer usable program instructions, or computer readable program instructions that can be read and executed by a processor in processor unit 804. The program instructions in the different embodiments can be embodied on different physical or computer readable storage media, such as memory 806 or persistent storage 808.

Program instructions 818 are located in a functional form on computer readable media 820 that is selectively removable and can be loaded onto or transferred to data processing system 800 for execution by processor unit 804. Program instructions 818 and computer readable media 820 form computer program product 822 in these illustrative examples. In the illustrative example, computer readable media 820 is computer readable storage media 824.

Computer readable storage media 824 is a physical or tangible storage device used to store program instructions 818 rather than a medium that propagates or transmits program instructions 818. Computer readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 818 can be transferred to data processing system 800 using a computer readable signal media. The computer readable signal media are signals and can be, for example, a propagated data signal containing program instructions 818. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 820” can be singular or plural. For example, program instructions 818 can be located in computer readable media 820 in the form of a single storage device or system. In another example, program instructions 818 can be located in computer readable media 820 that is distributed in multiple data processing systems. In other words, some instructions in program instructions 818 can be located in one data processing system while other instructions in program instructions 818 can be located in one data processing system. For example, a portion of program instructions 818 can be located in computer readable media 820 in a server computer while another portion of program instructions 818 can be located in computer readable media 820 located in a set of client computers.

The different components illustrated for data processing system 800 are not meant to provide architectural limitations to the manner in which different embodiments can be implemented. In some illustrative examples, one or more of the components may be incorporated in or otherwise form a portion of, another component. For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program instructions 818.

Thus, illustrative embodiments provide a computer implemented method, computer system, and computer program product for analyzing a domain name for maliciousness. In one illustrative example, a method analyzes a domain name. A number of processor units identifies the domain name for analysis. The number of processor units splits the domain name into tokens. The number of processor units combines the tokens into different arrangements to form permutated domain names. The number of processor units identifies features for the permutated domain names using a set of domain name databases. The number of processor units analyze the permutated domain names with the features to determine maliciousness of the domain name.

The illustrative examples can analyze a domain name for maliciousness without the number of features normally desired for analyzing domain names. In illustrative examples, additional features can be identified for use in analyzing the domain name through generating permutations of the domain name and identifying features for those permutations. In these illustrative examples, this analysis can be useful when domain names are new or are not found in threat databases. The illustrative example provides an approach to for systematic DNS threat hunting for threats posed by a domain name without needing prior knowledge of that domain name. The use of permutated domain names and the features to identify threats for those permutated domain names are used to understand the maliciousness of the domain name from which the permutated domain names are generated. As a result, the list of examples can be used to identify maliciousness of a single domain name even though few DNS records may be present, and nothing may be running using the domain name.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for analyzing a domain name, the computer implemented method comprising:
identifying, by a number of processor units, the domain name for analysis;
splitting, by the number of processor units, the domain name into tokens;
combining, by the number of processor units, the tokens into different arrangements to form permutated domain names;
identifying, by the number of processor units, features for the permutated domain names using a set of domain name databases; and
analyzing, by the number of processor units, the permutated domain names with the features to determine a maliciousness of the domain name.

2. The computer implemented method of claim 1, further comprising:
performing, by the number of processor units, a set of actions for the domain name identified based on the maliciousness of the domain name.

3. The computer implemented method of claim 1, wherein analyzing, by the number of processor units, the permutated domain names with the features to determine the maliciousness of the domain name comprises:
analyzing, by the number of processor units, the permutated domain names with the features identified for the permutated domain names to identify a threat level for the domain name.

4. The computer implemented method of claim 1, wherein analyzing, by the number of processor units, the permutated domain names with the features identified is performed using at least one of a rule-based engine or a machine learning model.

5. The computer implemented method of claim 1, wherein permutation of tokens to form the permutated domain names is performed using tokens excluding a top level domain in the domain name.

6. The computer implemented method of claim 1, wherein permutation of tokens to form the permutated domain names is performed using tokens from a root domain of the domain name.

7. The computer implemented method of claim 1, wherein the set of actions is selected from at least one of updating a threat intelligence database, blocking a lookup of the domain name in a domain name system service, or generating an alert.

8. The computer implemented method of claim 1, wherein the set of domain name databases is selected from at least one of a domain registration database, a domain name system database, a domain lookup database, a threat intelligence database, a threat intelligence domain database, or a threat intelligence index.

9. The computer implemented method of claim 1, wherein the features for a permutated domain name in the permutated domain names are selected from at least one of an Internet Protocol address, a registrar name, a registrant name, registrant information, an administrative contact, a technical contact, a name server, domain status, a creation date for a registered domain name, an expiration date for the registered domain name, a threat actor, a threat level, or a maliciousness level.

10. A computer system comprising:
a number of processor units, wherein the number of processor units executes program instructions to:
identify a domain name for analysis;
split the domain name into tokens;
combine the tokens into different arrangements to form permutated domain names;
identify features for the permutated domain names using a set of domain name databases; and
analyze the permutated domain names with the features to determine a maliciousness of the domain name.

11. The computer system of claim 10, wherein the number of processor units further executes program instructions to:
perform a set of actions for the domain name identified based on the maliciousness of the domain name.

12. The computer system of claim 10, wherein in analyzing, by the number of processor units, the permutated domain names with the features to determine the maliciousness of the domain name, the number of processor units further executes program instructions to:
analyze the permutated domain names with the features identified for the permutated domain names to identify a threat level for the domain name.

13. The computer system of claim 10, wherein analyzing the permutated domain names with the features identified is performed and an analytical component selected from at least one of a rule-based engine or a machine learning model.

14. The computer system of claim 10, wherein the set of actions is selected from at least one of updating a threat intelligence database or generating an alert.

15. The computer system of claim 10, wherein permutation of tokens to form the permutated domain names is performed using tokens excluding a top level domain in the domain name.

16. The computer system of claim 10, wherein permutation of tokens to form the permutated domain names is performed using tokens from a root domain of the domain name.

17. The computer system of claim 10, wherein the set of domain name databases is selected from at least one of a domain registration database, a domain name system database, a domain lookup database, a threat intelligence database, a threat intelligence domain database, or a threat intelligence index.

18. The computer system of claim 10, wherein the features for a permutated domain name in the permutated domain names are selected from at least one of an Internet Protocol address, a registrar name, a registrant name, registrant information, an administrative contact, a technical contact, a name server, a creation date for a registered domain name, an expiration data for the registered domain name, a threat actor, or a maliciousness level.

19. A computer program product for analyzing a domain name, the computer program product comprising a computer readable storage medium having program instructions embodied therewith, the program instructions executable by a number of processor units to cause the number of processor units to:
identify the domain name for analysis;
split the domain name into tokens;
combine the tokens into different arrangements to form permutated domain names;
identify features for the permutated domain names using a set of domain name databases; and
analyze the permutated domain names with the features to determine a maliciousness of the domain name.

20. The computer program product of claim 19, wherein the program instructions are executable by a number of processor units to further cause the number of processor units to:
perform a set of actions for the domain name identified based on the maliciousness of the domain name.
